(19) United States
(12) Patent Application Publication
(10) Pub. No.: US 2008/0257646 A1
(43) Pub. Date: Oct. 23, 2008

(54) Segmented Surface Element and Rigidizer and Uses Thereof

(76) Inventor: Dror Gat, Tel Aviv (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/097,874

(22) PCT Filed: Dec. 14, 2006
(86) PCT No.: PCT/IL2006/001437

§ 371 Date: Jun. 17, 2008

(30) Foreign Application Priority Data
Dec. 18, 2005 (IL) 172,664

(51) Int. Cl. E04B 1/344

(52) U.S. Cl. 182/223

(57) ABSTRACT

The invention provides a segmented surface 10 having a series of elements 12 hingedly attached to each other, the hinges 14 enabling the elements 12 to be rolled into a compact array and to be rotated and extended vis-a-vis adjacent elements 12 to ascribe predetermined angles therebetween, and comprising additional elements 18, each additional element 18 being hingedly attached to the hinge 14 of a pair of adjacent surface elements 12, wherein the hinges 14 enable the additional element 18 to be rotated vis-a-vis a commonly hinged surface element to ascribe an angle of between 10° and 350° relative thereto.

The present invention relates to modular surface structures.

More particularly, the invention provides a primary hinged surface element and a second hinged element which can be used to rigidize a structure composed of multiple primary surface elements. The structure can be rolled up for storage and transport. Applications are many, those described in the present specification include dismountable platforms, window shades, building elements, bridges, a pool deck or cover, stretcher and a ladder. Auxiliary components are required for some of these applications.

Interlocking structural elements are well known, examples being interlocking floor tiles, aluminium facing profiles, wooden facing strips for interiors, and facing stones for building exteriors. All these are intended for permanent attachment and construction.

Examples of modular building construction are seen in U.S. Pat. Nos. 4,712,352; 4,802.500; 6,615,999; 6,645,871 and others. None are of the roll-up type.

The armed forces, sports organizations and some industrial concerns may require light-weight temporary structures, which can be deployed quickly and easily, which can be modified if needed, can be transported and stored in a compact manner, and can be reused in a second location. The armed forces in particular are constantly being faced with changing circumstances such as the need to construct temporary structures to serve as a helicopter landing pad, a store, a bridge or a house-like enclosure. By use of conventional building methods the structures are permanent and unmovable, and require destruction if there is a danger of enemy forces capturing the area in which said structures are located.

A search of US, European and other patents failed to find any system that meets these requirements. The temporary structures seen in the prior art require dismantling for transport and compact storage, and reassembly on redeployment, both of which consume time that may not be available in the field. Furthermore none of the systems reviewed are equipped with deployable rigidizers, which greatly add to the rigidity of the surface being constructed. Examples of prior art temporary construction surfaces are seen in U.S. Pat. Nos. 4,811,530 and 6,736,446.

It is therefore one of the objects of the present invention to obviate the disadvantages of prior art construction systems and to provide components which can be used for temporary construction of surfaces and on conclusion of use can be rolled up for compact transport and storage.

It is a further object of the present invention to provide a system that includes automatic or manual deployment of rigidizing beams attached underneath the surface elements which form the primary construction component.

The present invention achieves the above objects by providing a segmented surface having a series of elements hingedly attached to each other, said hinges enabling said elements to be rolled into a compact array and to be rotated and extended vis-à-vis adjacent elements to ascribe predetermined angles therebetween, and comprising additional elements, each additional element being hingedly attached to the hinge of a pair of adjacent surface elements, wherein said hinges enable said additional element to be rotated vis-à-vis a commonly hinged surface element to ascribe an angle of between 10° and 350° relative thereto.

In a preferred embodiment of the present invention there is provided a segmented surface, wherein said surface elements are substantially in the form of quadrilateral plates.

In another preferred embodiment of the present invention there is provided a segmented surface, wherein said additional elements are substantially in the form of quadrilateral plates.

In a further preferred embodiment of the present invention there is provided a segmented surface, having a series of surface elements hingedly attached to each other to form a longitudinally-extending surface, characterized in that said additional elements extend substantially perpendicular to said longitudinally-extending surface, to provide structural support for said surface along the lateral axis of the respective hinges from which said additional elements depend.

In a further preferred embodiment of the present invention there is provided a segmented surface, whenever used to form a weight-supporting platform.

In a further preferred embodiment of the present invention there is provided a segmented surface, whenever used to form a weight-supporting bridge.

In a further preferred embodiment of the present invention there is provided a segmented surface, whenever used to form a weight-supporting pool deck or pool cover.

In yet a further preferred embodiment of the present invention there is provided a segmented surface, whenever used to form a weight-supporting stretcher.

In a further preferred embodiment of the present invention there is provided a segmented surface, whenever used to form a weight-supporting landing surface for helicopters.

In another preferred embodiment of the present invention there is provided a segmented surface, whenever used to form a weight-supporting enclosure.

In yet a further preferred embodiment of the present invention there is provided a segmented surface, wherein said additional elements are interconnected to each other by means enabling the controlled rotation thereof to at least one predetermined angle, vis-à-vis said segmented surface.

In another preferred embodiment of the present invention there is provided a segmented surface wherein said surface elements are at least partially transparent and said additional elements are at least partially opaque and said controlled rotation of said additional elements enables the control of the passage of light through said surface elements.

In another embodiment of the present invention either the surface elements or the additional elements can be made porous for enabling controlled entry of air therethrough.

In another preferred embodiment of the present invention there is provided a segmented surface having a series of surface elements having two major faces, two longitudinal side edges and two lateral edge faces, a first lateral edge face supporting a plurality of spaced-apart first loop members, the second lateral edge supporting a plurality of spaced-apart loop members spaced in a manner allowing adjacent pivoted interconnection to a first edge face of a substantially identical second surface element, a hinged additional element of substantially the same width as said surface elements, said additional element being provided with a plurality of spaced-apart third loop members positioned to allow revolvable interconnection along a pivot axis already partially occupied by said first and said second loop members, and a hinge pin substantially as long as said lateral edge of said surface elements, said pin being insertable through said first, second and third loop members to hingedly attach an additional element to a pair of interconnected adjacent surface elements.

In another preferred embodiment of the present invention there is provided a roll-up bridge for use above ground level comprising a plurality of surface elements, wherein said surface elements are hingedly attached to each other by axially extended hinge pins projecting beyond both lateral edges of said surface elements, ground support pillar elements as required by the level of the ground and the desired height of said bridge, and a pair of flexible tension members engaging and supporting the ends of said hinge pins.

With regard to the roll-up bridge, in a preferred embodiment said pair of flexible tension members are steel cables.

In another preferred embodiment of the present invention there is provided a segmented surface wherein said surface elements are buoyant.

In yet another preferred embodiment of the present invention there is provided a segmented surface composed of a series of surface elements hingedly attached to each other to form an extended surface, two parallel set-apart, longitudinally extending side surfaces and further comprising a rigidifying rail element affixed to at least one of said side surfaces wherein said rail is non-linear along portions of its length and ascribes predetermined angles complementary to angular connections between hingedly attached adjacent surface elements.

In one more preferred embodiment of the present invention there is provided a segmented surface wherein said extended attached surface elements ascribe an angle of about 180° relative to each other.

It will thus be realized that the novel device of the present invention serves many purposes, and whether the surface elements are made of plastic, of an obtuse or transparent material, or of a light metal or steel depends entirely on the application, which dictates the balance between strength, light weight and lowest cost.

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

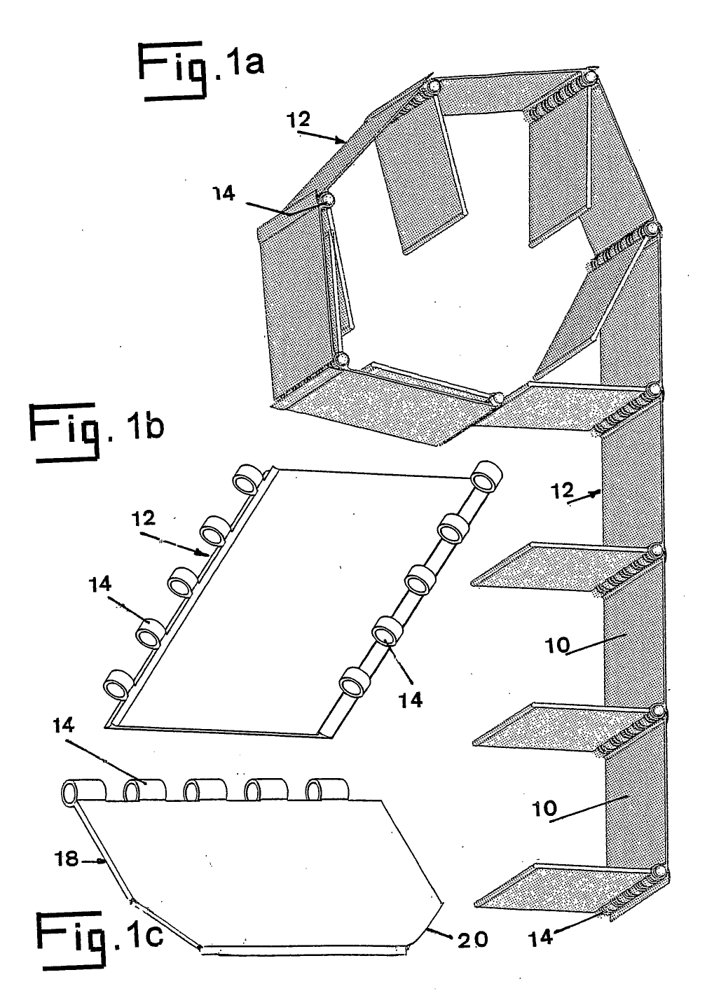

FIG. 1a is a perspective view of a preferred embodiment of the segmented surface seen partially rolled up, according to the invention;

FIG. 1b is an underside perspective view of a preferred surface element;

FIG. 1c is a perspective view of an additional element to be suspended below the surface elements;

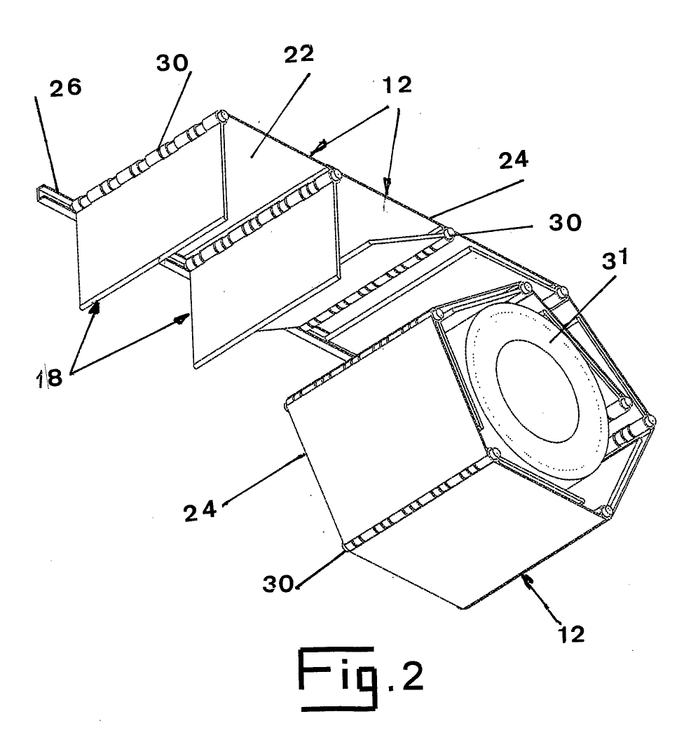

FIG. 2 is an underside perspective view of a preferred embodiment provided with a guide rail;

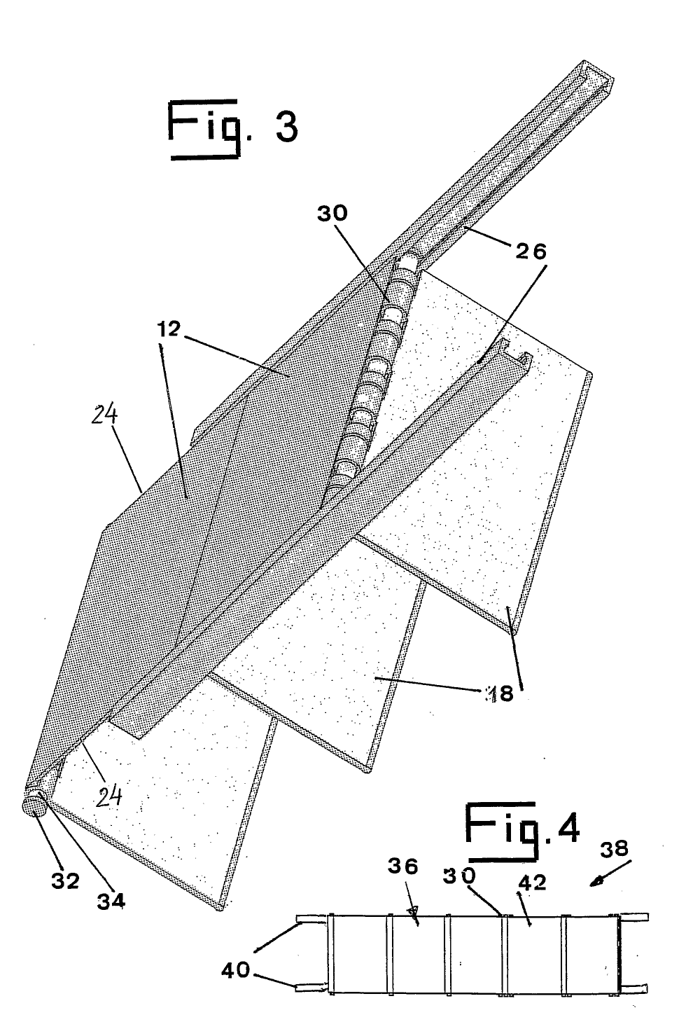

FIG. 3 is a perspective view of a deployed load-carrying embodiment provided with two guide rails;

FIG. 4 is a plan view of a stretcher constructed from surface elements;

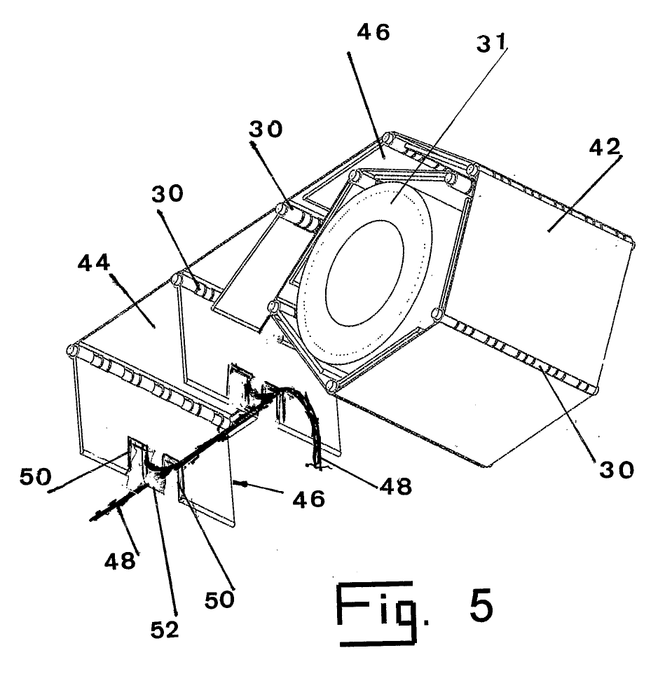

FIG. 5 is a perspective view looking upwards onto an embodiment partially deployed provided with a cable linking the additional elements;

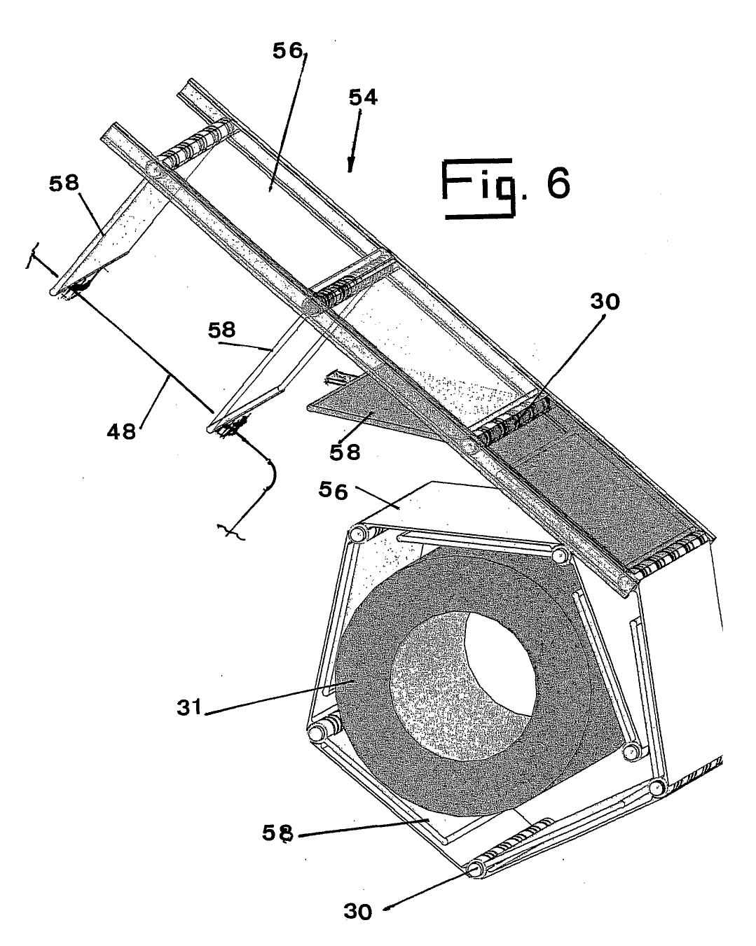

FIG. 6 is a perspective view of an embodiment providing control of light passing therethrough;

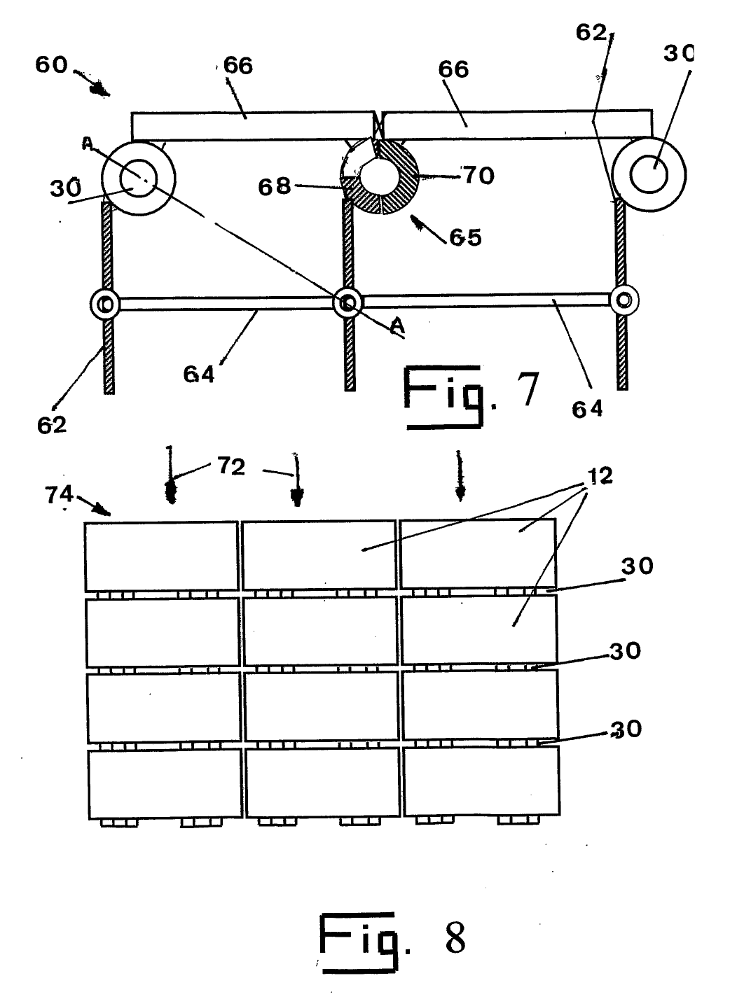

FIG. 7 is an elevational view of an embodiment provided with linkage;

FIG. 8 is a plan view of an array forming a large floor surface;

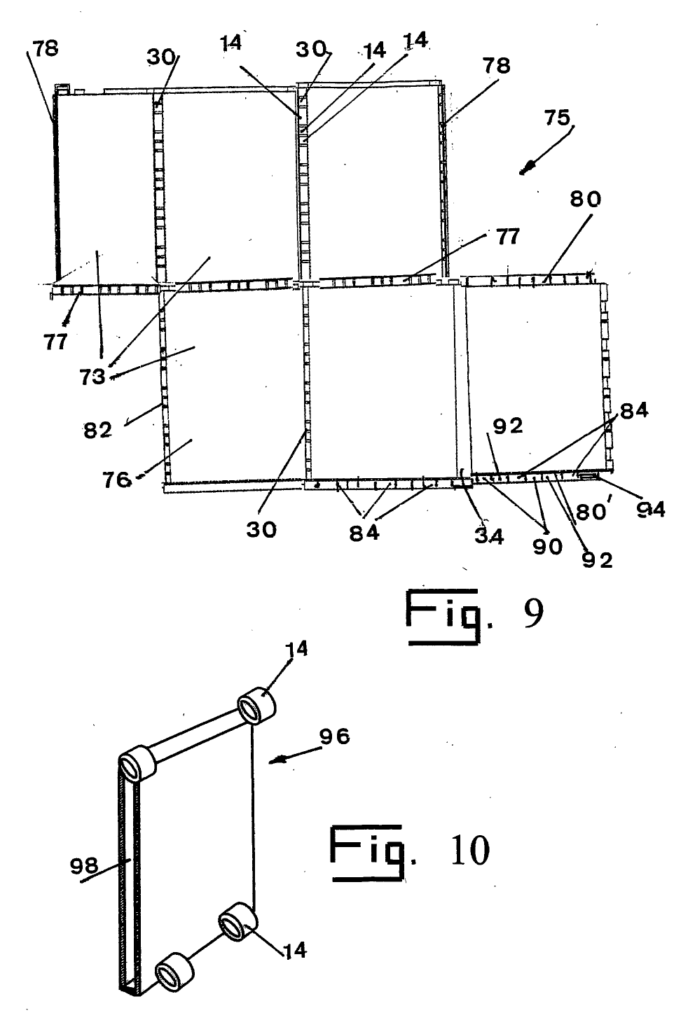

FIG. 9 is a plan view of an array wherein the surface elements are hingedly connected both longitudinally and laterally;

FIG. 10 is a sectioned perspective view of a hollow surface element;

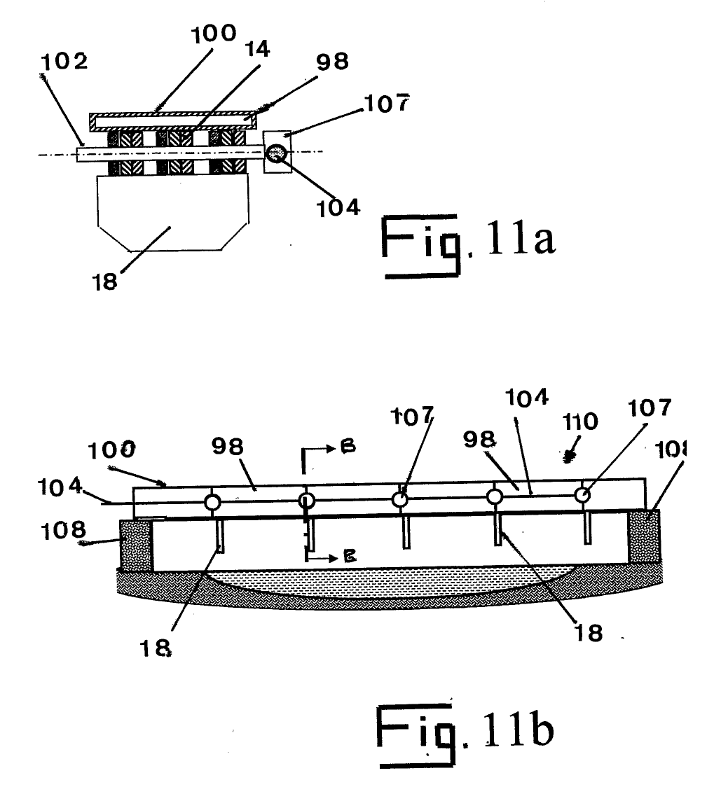

FIG. 11a is a section taken at BB in FIG. 11b;

FIG. 11b is an elevational view of a bridge constructed according to the present invention; and

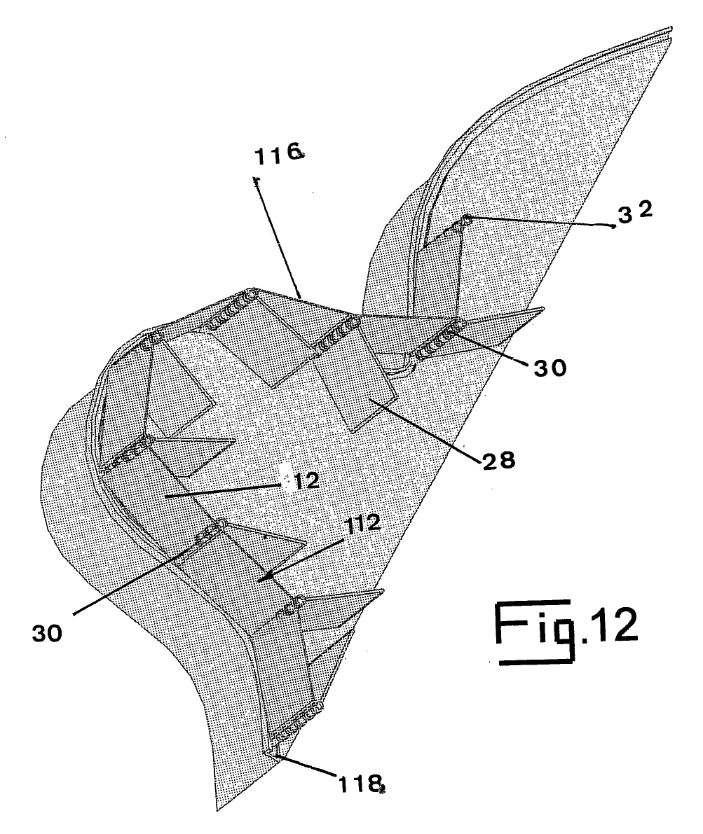

FIG. 12 is a perspective view of an embodiment wherein the desired surface is non-linear.

There is seen in FIG. 1a the underside of a segmented surface 10 formed by a series of surface elements 12 hingedly attached to each other. The surface 10 is typically horizontal, as will be seen more clearly in FIG. 3. The hinges 14 provided enable the elements 12, best seen in FIG. 1b, to be rolled into a compact array 16, as seen in FIG. 2, and to be rotated and extended vis-à-vis adjacent elements 12 to ascribe predetermined angles therebetween, as seen, e.g., in FIG. 3.

An additional element 18, seen best in FIG. 1c, can be hingedly attached to the hinge 14 of a pair of adjacent surface elements 12. The hinges 14 enable the additional element to be rotated vis-à-vis a commonly hinged surface element to ascribe an angle of between 10° and 350° relative thereto.

For high load applications, for example a military bridge (to be described with reference to FIG. 11), the surface elements 12 and the additional elements 18 are made of metal.

For lighter duty applications, for example a wall surface, or an application where light weight and greater flexibility are needed, the surface elements 12 and the additional elements 18 are made of plastic.

Normally, as seen in the figures, the surface elements 12 are substantially in the form of quadrilateral plates. So too the additional elements 18, except that the plate corners remote from the hinge area, are in some applications advantageously chamfered 20, as shown in FIG. 1c.

With regard to the rest of the figures, similar reference numerals have been used to identify similar parts.

Referring now to FIG. 2, there is again seen the underside of a segmented surface 22. A series of surface elements 12 are hingedly attached to each other to form a longitudinally-extending segmented surface. When deployed the elements 12 form two parallel, set-apart longitudinally-extending side surfaces 24, seen also in FIG. 3, which are slidingly engaged by a rigidifying rail element 26. Where long time usage is expected the rail 26 may be affixed to one of the side surface 24 by means of a sealant.

After the device is unrolled the additional elements 18 extend by gravity to take up a position substantially perpendicular to the longitudinally-extending surface 22. This provides structural support and greatly increases rigidity for the surface along the lateral axis of the respective hinges 30 from which the additional elements 18 depend.

After deployment the extended attached surface elements 12 ascribe an angle of about 180° relative to each other.

A light-weight cylinder 31 is useful for roll-up.

FIG. 3 illustrates a plurality of interconnected segmented surface elements 12 assembled to form a weight-supporting platform. Two rigidifying rail elements 26 are seen. The rails 26 slidingly engage an extension 32 of the hinge pin 34. The platform can be arranged to serve as a weight-supporting bridge, a weight-supporting pool deck, at least a segment of a weight-supporting landing surface for helicopters, an emergency ladder or the surface of an enclosure.

Seen in FIG. 4 is a segmented surface 36 used to form a weight-supporting stretcher 38. Four handles 40 have been added at the corners of the stretcher. The surface segments 42 in the present embodiment are preferably made of a plastic. When deployed the stretcher 38 rests on the additional elements, on its lower side and not seen in this figure. When not in use the stretcher 38 is rolled up for ease of transport and storage.

Turning now to FIG. 5, there is seen the underside of a partially-deployed segmented surface 44. The additional elements 46 are interconnected to each other by a steel cable 48, enabling the controlled rotation of the elements 46 to a predetermined angle, vis-à-vis the segmented surface 44. A pair of recesses 50 are provided so that the cable 48 can be wound around the central tongue 52 of each element 46. Thus the cable 48 is readily removable before roll-up, as seen on the right side of the figure.

Turning now to FIG. 6, there is seen a partially-deployed segmented surface 54 built of surface elements 56 which are substantially transparent. However, the additional elements 58 are at least partially opaque. The controlled rotation of the additional elements 58 enables the control of the passage of light through the surface elements 56.

A steel cable 48 is seen enabling the controlled rotation of the additional elements 58. The cable is removed before roll-up.

The assembly may be used to form a roof surface, a wall surface or a pergola.

FIG. 7 illustrates details of an embodiment of a segmented surface 60 wherein the means enabling the controlled rotation of the additional elements 62 are rigid links 64. The additional elements 62 are provided with stop and locking means 65 controlling the rotation thereof vis-à-vis commonly hinged surface elements 66 to ascribe an angle of about 90° relative thereto when deployed. The stop means 65 are seen in the central portion of the figure. A sector of the hinge collar 68 of the additional element 62 extends about 90° and abuts a step on the hinge collar 70 of the surface element 66 which extends over about 180°, thus leaving the additional element a possible motion of about 90°. If locking is desired, a diagonal strut is connected on the line AA. The links 64, and strut if needed, are removed before roll-up.

The shown embodiment is configured to function as a roll-up emergency ladder when positioned in a near-upright manner.

Seen in FIG. 8 is a plurality of segmented surface elements 12, adjacently aligned to form a composite segmented surface array 74. The array as shown in the figure comprises a number of independent columns 72. There is no lateral connection. Thus the array 74 can be used on uneven ground, as each column 72 is free to adapt to the shape of the ground surface.

Referring now to FIG. 9, there is depicted a segmented surface comprising a series of surface elements 73 provided with hinge interconnections 77 laterally as well as longitudinally to form an array 75.

Each surface element has two major faces 76, two longitudinal side edges 78 and two lateral edge faces 80, as seen more clearly in FIG. 1b. A first lateral edge face 76 supports a plurality of spaced-apart first loop members 82. The second lateral edge 76′ supports a plurality of spaced-apart loop members 84 spaced in a manner allowing adjacent pivoted interconnection to a first lateral edge face 76 of a substantially identical second surface element 74′.

A hinged additional element 86, seen most clearly in FIG. 4, of substantially the same width as the surface elements 74 is provided with a plurality of spaced-apart third loop members 88 positioned to allow revolvable interconnection along a pivot axis already partially occupied by the first and the second loop members 90, 92. These are seen most clearly in FIG. 2.

A hinge pin 94, seen in FIG. 11a, is substantially as long as the lateral edge of the surface elements 74. The pin 94 is inserted through the first, second and third loop members 88, 90, 92 to hingedly attach an additional element 86 seen in FIG. 4 to a pair of interconnected laterally-adjacent surface elements 74, 74′.

The array 75 is intended for use as a substantially flat surface. Where the surface elements are made of plastic, some substantial irregularities in the ground to be covered can be accepted.

FIG. 10 shows a surface element 96 having a rectangular tubular structure. The tubular structure provides maximum resistance to the bending of the surface elements when under a heavy load. Tubular construction is also important in preventing distortion of the additional elements providing rigidity under load.

A further benefit of the tubular construction is that the end faces can be sealed to provide a buoyant surface element and so form a pontoon bridge.

Seen in FIG. 11a is a detail of a roll-up bridge 110, seen in FIG. 11b spanning a water barrier. The bridge is intended for use above ground level.

A segmented surface 100 is formed by an array of surface elements 98 hingedly attached to each other by axially extended hinge pins 102. Lateral rigidity is provided by the additional element 106. The pins project beyond the lateral edges of the surface elements 98. Preferably the surface elements 98 are made of rust-protected steel.

At least one steel cable 104 engages the head 107 of the hinge pins 102. The cable is tensioned and anchored by prior art procedures.

Suitable ground support pillar elements 108 are used in accordance with the level of the ground and the desired height of the bridge.

The cable(s 104 are) is removed before roll-up.

With reference now to FIG. 12, there is seen a segmented surface 112 having a series of surface elements 12 hingedly attached to each other to form an extended surface interconnecting parallel, set-apart, longitudinally extending side surfaces 116.

A rigidifying rail element 118 is affixed to at least one of the side surfaces 116. The rail 118 is non-linear along portions of its length and ascribes predetermined angles complementary to angular connections between hingedly attached adjacent surface elements 12.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A segmented, weight-supporting surface having a series of elements hingedly attached to each other, said hinges enabling said elements to be rolled into a compact array and to be rotated and extended vis-à-vis adjacent elements to ascribe predetermined angles therebetween, and comprising additional elements, each additional element being hingedly attached to the hinge of a pair of adjacent surface elements, wherein said hinges enable said additional element to be rotated vis-à-vis a commonly hinged surface element to ascribe an angle of between 10° and 350° relative thereto.

2. A segmented, weight-supporting surface according to claim 1, wherein said surface elements are substantially in the form of quadrilateral plates.

3. A segmented, weight-supporting surface according to claim 1, wherein said additional elements are substantially in the form of quadrilateral plates.

4. A segmented, weight-supporting surface according to claim 1, having a series of surface elements hingedly attached to each other to form a longitudinally-extending surface with two parallel, set-apart longitudinally-extending side surfaces and further comprising a rigidifying rail element affixed to at least one of said side surfaces.

5. A segmented, weight-supporting surface according to claim 1, having a series of surface elements hingedly attached to each other to form a longitudinally-extending surface, characterized in that said additional elements extend substantially perpendicular to said longitudinally-extending surface, to provide structural support for said surface along the lateral axis of the respective hinges from which said additional elements depend.

6. A segmented, weight-supporting surface according to claim 1, whenever used to form a weight-supporting platform.

7. A segmented, weight-supporting surface according to claim 1, whenever used to form a weight-supporting bridge.

8. A segmented, weight-supporting surface according to claim 1, whenever used to form a weight-supporting pool deck.

9. A segmented, weight-supporting surface according to claim 1, whenever used to form a weight-supporting stretcher.

10. A segmented, weight-supporting surface according to claim 1, whenever used to form at least a segment of a weight-supporting landing surface for helicopters.

11. A segmented surface having a series of elements hingedly attached to each other, said hinges enabling said elements to be rolled into a compact array and to be rotated and extended vis-à-vis adjacent elements to ascribe predetermined angles therebetween, and comprising additional elements, each additional element being hingedly attached to the hinge of a pair of adjacent surface elements, wherein said hinges enable said additional element to be rotated vis-à-vis a commonly hinged surface element to ascribe an angle of between 10° and 350° relative thereto whenever used to form a surface of an enclosure.

12. A segmented surface according to claim 1, wherein said additional elements are interconnected to each other by means enabling the controlled rotation thereof to at least one predetermined angle, vis-à-vis said segmented surface.

13. A segmented surface according to claim 12, whenever said surface elements are at least partially transparent and said additional elements are at least partially opaque and said controlled rotation of said additional elements enables the control of the passage of light through said surface elements.

14. A segmented surface according to claim 12, wherein said means enabling the controlled rotation of said additional elements are cable means.

15. A segmented surface according to claim 12, wherein said means enabling the controlled rotation of said additional elements are linkage means.

16. A segmented surface according to claim 13, wherein said surface elements are used to form a roof surface.

17. A segmented surface according to claim 13, wherein said surface elements are used to form a wall surface.

18. A segmented surface according to claim 13, wherein said surface elements are used to form a pergola.

19. A segmented surface according to claim 1, wherein said additional elements are provided with stop and locking means controlling the rotation thereof vis-à-vis commonly hinged surface elements to ascribe an angle of about 90° relative thereto.

20. A segmented surface according to claim 19, whenever used to form a roll-up emergency ladder.

21. A plurality of segmented surfaces according to claim 1, adjacently aligned to form a composite segmented surface array.

22. A segmented surface according to claim 1, having a series of surface elements having two major faces, two longitudinal side edges and two lateral edge faces, a first lateral edge face supporting a plurality of spaced-apart first loop members, the second lateral edge supporting a plurality of spaced-apart loop members spaced in a manner allowing adjacent pivoted interconnection to a first edge face of a substantially identical second surface element, a hinged additional element of substantially the same width as said surface elements, said additional element being provided with a plurality of spaced-apart third loop members positioned to allow revolvable interconnection along a pivot axis already partially occupied by said first and said second loop members, and a hinge pin substantially as long as said lateral edge of said surface elements, said pin being insertable through said first, second and third loop members to hingedly attach an additional element to a pair of interconnected adjacent surface elements.

23. A segmented surface according to claim 1, wherein said surface elements and said additional elements are made of metal.

24. A segmented surface according to claim 1, wherein said surface elements and said additional elements are made of plastic.

25. A segmented surface according to claim 1, wherein said surface elements and said additional elements have a rectangular tubular structure.

26. A roll-up bridge for use above ground level comprising a segmented surface according to claim 1, wherein said surface elements are hingedly attached to each other by axially extended hinge pins projecting beyond both lateral edges of said surface elements, ground support pillar elements as required by the level of the ground and the desired height of said bridge, and a pair of flexible tension members engaging and supporting the ends of said hinge pins.

27. A roll-up bridge as according to claim 26, wherein said pair of flexible tension members are steel cables.

28. A segmented surface according to claim 1, wherein said surface elements are buoyant.

29. A segmented surface according to claim 1, having a series of surface elements hingedly attached to each other to form an extended surface to parallel, set-apart, longitudinally extending side surfaces and further comprising a rigidifying rail element affixed to at least one of said side surfaces wherein said rail is non-linear along portions of its length and ascribes predetermined angles complementary to angular connections between hingedly attached adjacent surface elements.

30. A segmented surface according to claim 1, wherein said extended attached surface elements ascribe an angle of about 180° relative to each other.
